(19) United States
(12) Patent Application Publication
(10) Pub. No.: US 2003/0191352 A1
(43) Pub. Date: Oct. 9, 2003

(54) Method of applying foam reagents for radioactive decontamination

(76) Inventors: David Bradbury, Gloucester (GB); George Richard Elder, Gloucester (GB)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/297,062

(22) PCT Filed: Apr. 26, 2001
(86) PCT No.: PCT/GB01/01890

(30) Foreign Application Priority Data
Jun. 9, 2000 (GB) 0014189.5

(51) Int. Cl. G21F 9/00

(52) U.S. Cl. 588/16

(57) ABSTRACT

A process for the chemical decontamination of a radioactive system or a system containing one or more radioactive components, which method comprises applying a chemical decontamination reagent to the radioactive system or the system containing one or more radioactive components in the form of a foam characterised in that a dynamic foam is caused to move through or around the system by means of a gas introduced into the system.

The present invention relates to a method of applying foam reagents for the radioactive decontamination of radioactive components.

The chemical decontamination of radioactive components is a now a well established procedure. Many components, particularly metallic ones, become contaminated with radioactive materials during the normal operation of a nuclear power plant or other nuclear facility. However, unless the component has been activated by a neutron flux, this contamination commonly occurs on the surface of the component only. Removal of the surface contamination can have significant benefits, and the process of doing this is generally referred to as “decontamination”. Specifically, when chemicals are used to remove the contamination from component surfaces the process is referred to as chemical decontamination.

The benefits of chemical decontamination include the reduction of radiation dose to people working on or close to, the component in question. More recently there are examples where the efficient decontamination of redundant components during decommissioning can allow the cleaned components to be released from radioactive materials controls so that they can be recycled or disposed of in a conventional manner. This not only has economic advantages, but benefits the environment as well through the recycling of valuable materials and the reduction in the volume of radioactive waste requiring disposal.

Physical decontamination methods (eg such as shot blasting) are often preferable to chemical methods for cleaning externally contaminated surfaces which are easily accessible. However, these methods cannot normally be applied conveniently to components of a complex structure or to systems where the contamination is on the inside of the component or system. Chemical decontamination is usually preferable for such tasks.

The process of chemical decontamination does not, of course, destroy the radioactivity; it merely separates it from the component into a different form of “secondary” radioactive waste. If the overall process is to achieve the desired benefit, the secondary waste must have a much smaller volume than the original component and must be in a form suitable to allow proper conditioning and processing for eventual disposal. In the prior art there are many examples of chemical decontamination processes which achieve this.

One technique, for example, is to use dilute chemical solutions and ion exchange clean-up. In this case the component or system is filled with water, the dilute chemicals are added and circulated to dissolve the surface contamination, and are then removed (together with the contamination) by filtration and ion exchange. The system starts and finishes full of clean water, and the ion exchange resin constitutes the radioactive “secondary” waste (eg. Petit, P. J., Le Surf, J. E., Steward, W. B., Strickert, R. J., Vaughan, S. B., Materials Performance, 1980, 19,1).

Although the preliminary step of filling a component or system with water for decontamination can normally be achieved, it is not always convenient. Some nuclear components are not designed to be filled with water, and the weight of the system when full would be in excess of the structural limits. An example of such a system is the “Magnox” gas-cooled reactor boiler. These items are carbon steel heat exchangers which (during operation) exchange heat from the reactor coolant gas to the water/steam circuit. The gas side of these boilers is contaminated, and was not originally designed to be filled with water. Another disadvantage of using water as the decontamination medium is that in systems with a large internal volume it is difficult to avoid stagnant pockets during the decontamination. If the chemical reagent used for decontamination is not efficiently circulated through the whole system volume during decontamination, then that part of the system in the stagnant pocket may not be efficiently cleaned. Such a problem would be encountered, for example, in attempting to decontaminate a Boiling Water Reactor Steam Turbine.

The restrictions on the weight of water could in principle be overcome by applying the chemical reagent in the form of foam, in which the liquid volume is highly expanded by entraining a gas.

The use of chemical reagents in the form of foam to decontaminate surfaces has been described in the prior art (for example, EP-A-0526305). In such cases the foam is formulated in a very specific manner to achieve particular properties of controlled duration before “collapse” (ie. reversion to liquid and gas phases). EP-A-0526305 refers specifically to the use of combinations of materials such as quaternary ammonium salts and oligosaccharides to achieve the result. Other foam decontamination applications have not been designed to address the problems described above but have been used for another purpose. In this case the objective is-the decontamination of an open surface by chemical reagent. If there is nothing to contain the liquid on the surface, decontamination with liquid can only be accomplished by continuously supplying fresh decontamination reagent to the surface, or by finding some other method of holding the reagent against the surface for the period during which chemical dissolution of the radioactive deposit takes place. Prior art applications of foam decontamination have involved the use of foam to hold the decontamination reagent against the surface for the dissolution period. The foam can thereafter be wiped or rinsed off. As would be expected for such an application, the foam is formed initially by entraining gas in the liquid decontamination reagent in a “foam generator” and then applying the foam to the surface in question.

A variation of the above procedure has also been described in which the foam is recirculated during use (French Patent No. 2773725). In this case the liquid is first formed into a foam and then recirculated through the system in question. This overcomes the problem of the weight restriction, but does not overcome the problem of stagnant pockets referred to above. French Patent No. 2773725 describes a particular procedure for generating reproducible foam by passing a liquid and gas phase through a porous layer. The foam can be collapsed, purified and reconstituted for re-injection. Such a procedure is particularly suitable for decontamination under conditions of reduced pressure.

We have now developed an improved process for the chemical decontamination of radioactive surfaces using an adaption of the prior art foam decontamination technology.

Accordingly the present invention provides a process for the chemical decontamination of a radioactive system or a system containing one or more radioactive components, which method comprises applying a chemical decontamination reagent to the radioactive system or the system containing one or more radioactive components in the form of a foam characterised in that a dynamic foam is caused to move through or around the system by means of a gas introduced into the system.

In a preferred aspect the dynamic form is formed in situ in the system by introducing a liquid volume of the decontamination reagent containing a foaming agent into the system and introducing a gas into the liquid volume of the decontamination reagent to form the foam.

The foam decontamination reagent used in the present invention is formulated from two principal components:

(i) a water-based chemical reagent of a type typically used for chemical decontamination in water based solution, and

(ii) a foaming agent which has the property of causing the water-based solution to entrain bubbles of gas to expand its volume in the form a foam.

The said foam decontamination reagent is placed inside the system, or a system containing a component to be decontaminated, in an appropriate quantity to occupy a small proportion of the overall system volume. This proportion may be any proportion between about 0.1% and 50%, but most preferably is between 1% and 10% of the system volume.

Gas is introduced through a suitable inlet or inlets into the liquid volume at the bottom of the system. The gas becomes entrained to expand the liquid and thereby cause it to fill the entire volume of the system. The foam so formed is a dynamic, rather than a static foam and this results in all of the foam reagent coming into contact with the surfaces to be treated during the course of the decontamination.

When the decontamination reagent capacity is used up, the gas flow is ceased, the foam collapses and the liquid is allowed to collect at the bottom of the system. The decontamination liquid is then removed from the system for example by pumping out or by gravity drain.

The system surfaces are rinsed with clean water and, if necessary, returned to a dry condition thereafter.

The present invention can be applied to an enclosed system in a nuclear plant (eg the inside of a boiler or turbine) or can be applied to components placed in an external tank.

A foam decontamination reagent is formulated as an aqueous solution of two principal components: The first component has the purpose of dissolving or loosening the radioactive material on the surface to be decontaminated. This component may be any chemical decontamination reagent normally used in the art. Examples are phosphoric acid, ethylene diamine tetraacetic acid, citric acid and combinations thereof. The second component (the “foaming agent”) is a chemical or chemicals which has the property of causing the water based solution to entrain bubbles of gas to expand its volume in the form a foam. An example of such a chemical is a non-ionic surfactant such as polyethoxyethylene lauryl ether, but any chemical can be used which has the said property.

All of the chemicals used in forming the decontamination reagent may ultimately become part of the radioactive waste arising from the process. They must therefore either be suitable for this purpose or be capable of conversion to harmless products (eg carbon dioxide gas) which are separated from the waste. Chemicals which are classed as chelating agents, for example, may be unsuitable for disposal in a radioactive waste package and volatile chemicals should be avoided because they can create problems relating to gaseous environmental discharges from the process.

Certain decontamination reagents which are capable of producing a foam, containing both the components described above, are commercially available and are suitable for use in the present invention. An example of such a reagent for decontaminating carbon steel systems is “EP 3019”, a product supplied by Brent Europe Ltd. This chemical can be diluted as required with water before use, in order to achieve the chemical cleaning capacity and foam stability properties required.

The amount of decontamination reagent required in the formulation should be sufficient to dissolve the total amount of contamination. This can be calculated by considering the surface area of the component or system to be cleaned and multiplying by an estimated thickness of metal or deposit (typically 10-20 microns) to be removed. The correct thickness to be removed to achieve decontamination can be determined by decontaminating a small artefact under laboratory conditions. The deposit volume divided by its density gives the deposit mass to be dissolved, and this in turn can be used to determine the decontamination reagent quantity required by considering the stoichiometry of the dissolution reaction (eg equation 1)

3Fe+2H₃PO₄-->Fe₃(PO₄)₂+3H₂

If it is not convenient to remove all of the contamination in just one application, the process can be repeated as many times as required. The concentration and type of foaming agent used should be chosen to achieve the correct properties of foam expansion and collapse. The amount and type of the chemical added is such as to allow the foam to expand to fill the full system volume (eg a volume expansion most preferably of a factor of 10 to 100). The foam must also readily collapse and return to the normal liquid state after the gas flow ceases. The collapse of the foam and its replacement by new foam generated from gas flow through the liquid at the bottom of the system is an important method for achieving the aforementioned objective of moving the foam over the system surfaces. For this reason the time for the foam to collapse to the liquid phase (after ceasing gas flow) should preferably be between about 10 minutes and one hour.

Gas is introduced through a suitable inlet or inlets into the liquid volume at the bottom of the system. The inlets may incorporate suitable nozzles or “diffusers” to encourage the gas to become entrained in the form of small bubbles. The gas used may be any suitable gas, but most preferably is compressed air, on the grounds of cost and convenience. The gas becomes entrained to expand the liquid and thereby cause it to fill the entire volume of the system. The access of foam to a large system may also be supplemented by withdrawing liquid from the bottom of the system, entraining gas in it in an external vessel with gas inlets as described above, and re-introducing the foam into particular parts of the system through an injection lance. The gas flow is controlled to prevent the foam rising above the top of the system volume. The gas is exhausted from the top of the system in a manner normally practised in the ventilation of radioactive areas, for example by extraction to atmosphere through a HEPA (high efficiency particulate) filter. The extract system may additionally contain a device to assist the collapse of foam if any foam should inadvertently reach the extract system. Liquid collected in the foam collapsing device is returned to the bottom of the system.

There is another important advantage of maintaining a gas flow through the system during the foam decontamination as described in the present invention. Decontamination of metal components with acidic reagents typically leads to the generation of some hydrogen gas. The hydrogen gas can become an explosion hazard if it is allowed to build up in a concentration above the lower explosive limit (about 4% hydrogen in air). The flow of gas dilutes the evolved hydrogen and allows it to be maintained below the lower explosive limit.

The method of introduction of the gas is an important means for causing the foam to move over and access all of the surfaces to be decontaminated. Any method, or combination of methods, which causes efficient motion of the foam over the system surfaces can be used. For example, the foam can be made to expand and collapse by starting and stopping the gas flow. This is a very effective technique for ensuring that the foam accesses all interstices within the system. Alternatively the gas can be introduced on one side of the system so that it rises vertically. The collapsing foam will then fall back over the system surfaces on the opposite side. Finally the gas can be introduced at such a rate that the foam may be held in dynamic equilibrium (in which the rate of foam generation exactly matches the rate of foam collapse). In this way the system may be held full of foam with a constant flow of gas rising through it. The most effective method, or combination of methods, is chosen with reference to the shape of the system to be decontaminated.

Chemical analysis is performed on samples of the liquid withdrawn from the bottom of the system. When the decontamination reagent capacity is used up (as evidenced by the metal concentration in solution or the solution pH), the gas flow is ceased and the liquid is allowed to collect at the bottom of the system. The foam decontamination liquid is then removed from the system for example by pumping out or by gravity drain.

After the process steps detailed above, the system is then rinsed with clean water to complete the decontamination. The rinsing is achieved by dispensing water with spray lances into suitable points within the system. Rinse water collected at the bottom of the system is removed in the same manner as the spent decontamination reagent.

The radioactive waste management of the combined foam and rinsing solution employs methods and principles typical of those used in the art. A filter may be used to remove insoluble particulate material from the waste solution. The waste solution may then be routed to a waste holding tank. In this tank the solution may then be mixed with chemicals added to achieve pH neutral conditions (eg magnesium hydroxide added to acid decontamination solutions). The liquid may then be routed to an evaporator. For evaporation to take place efficiently it may then be desirable to add a small amount of a suitable anti-foaming chemical. The condensate from the evaporation process can be recycled for use as rinse water or for further reagent make-up. The residue may be routed to waste drums for in situ grouting with cement. The waste drums would thereafter be sealed and transported away for burial. These types of operation are well established in the nuclear industry. However, other methods of managing the waste decontamination solution may also be appropriate in countries where it is permitted to discharge suitably treated liquid effluents.

The present invention will be further described with reference to the accompanying drawings, in which:

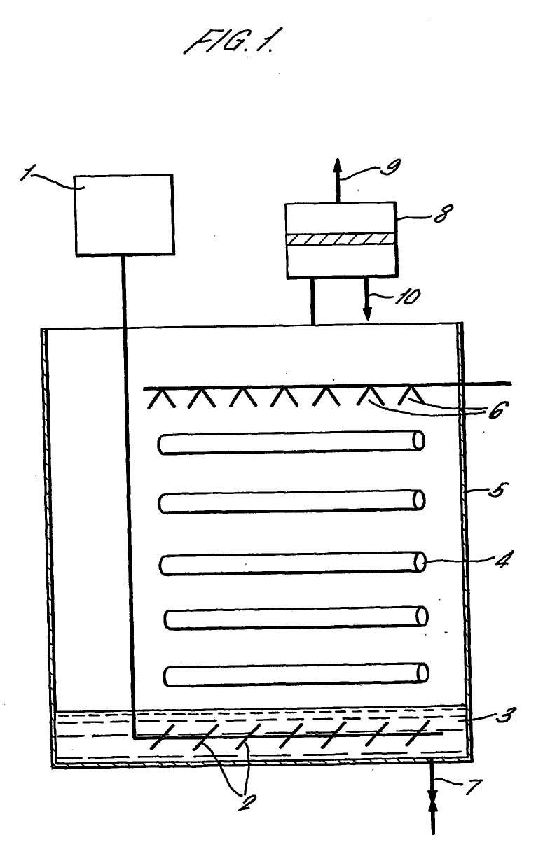

FIG. 1 is a diagrammatic representation of an apparatus for carrying out the present invention; and

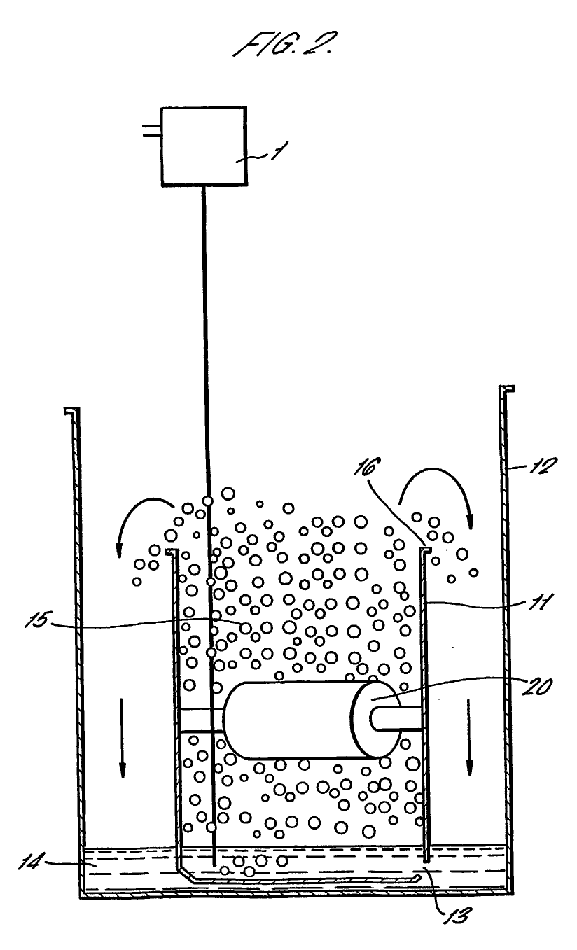

FIG. 2 is a diagrammatic representation of the apparatus used in Examples 1 to 3 herein.

Referring to FIG. 1, an enclosure 5 contains the items 4 to be decontaminated. Items 4 and enclosure 5 may be one integral unit. The decontamination liquid 3 is introduced into the enclosure 5 and is aspirated with a gas from compressor 1 through inlets 2. The resulting foam rises within the enclosure 5 to cover the items 4 to be decontaminated. The foam is collapsed in the foam collapsing device 8. Gas exits from this device at 9 and the liquid is returned to enclosure 5 via 10. After completion of the decontamination procedure the liquid is drained through 7 and the system spray rinsed with water via inlets 6. The rinsings are also drained through 7.

FIG. 2 illustrates an experimental set up for demonstrating the method of the invention. The sample to be decontaminated 20 is placed in an inner container 11 positioned within an outer container 12. The inner and outer containers 11 and 12 are connected together by means of a hole 13. Liquid decontamination reagent 14 is introduced into both the inner container 11 and outer container 12. The reagent is foamed in situ by the introduction of air through the liquid. The foam so produced as shown at 15 rises to cover the sample 20 to be decontaminated. The foam spilled over the top lip 16 of the inner container 11 and collapsed to form a liquid which was returned in the space between the inner and outer containers.

### EXAMPLES

### Example 1 (Comparative)

A sample of boiler tube was obtained from a “Magnox” nuclear reactor. The sample was of a “finned” construction”. The sample was of a tubular construction of outer diameter of 3.0 cm with eight fins having an outer diameter of 4.5 cm disposed around the tube. The fin thickness was 1.0 mm and the fin pitch 3.0 mm.

A sample of EP 3019 foam (Brent Europe Ltd—20% EP 3019 in deionised water) was prepared by blowing air through the liquid. The resulting foam was added to a beaker containing the finned boiler tube sample. The foam was allowed to collapse and after 50 minutes the sample was rinsed with a hand-held water sprayer. The cobalt-60 content of the sample was measured before and after decontamination by gamma spectroscopy. The ratio of Co-60 before decontamination to Co-60 after decontamination (decontamination factor, or DF) was 1.1.

### Example 2 (Comparative)

The experiment in Example 1 was repeated with another boiler tube sample, but using 40% EP3019 reagent instead of 20%. The DF achieved was 1.8.

### Example 3

A similar boiler tube sample to those used in Examples 1 and 2 was placed in an apparatus as shown in FIG. 2. The same amount of 40% EP3019 reagent was used as in Example 2. The reagent was introduced as a liquid and foam was generated in situ by blowing compressed air through the inner container. The foam collapsed and returned in the space between the outer and inner container. After a similar exposure time to that of Examples 1 and 2 the sample was rinsed with a hand-held water sprayer as in the previous example. The DF achieved was 7.0.

It can be seen that the process of the present invention is much improved over the process as described in Examples 1 and 2 in which the foamed reagent was not generated in situ. The disadvantages of the prior art method are discussed below:

The decontamination of the specimens using the prior art method required at least twenty minutes contact for the decontamination to take place. The foam was liable to collapse during the decontamination period, leaving the surface uncovered. It would be possible to overcome this problem by re-formulating the decontamination reagent (by using chemicals such as in EP-A-0526305, which stabilise the foam). However, the extra chemicals would have disadvantages from point of view of radioactive waste management.

The foam was static, which did not allow efficient use of the reagent. If the foam reagent is applied in the conventional way the majority of the foam simply fills the volume and has no contact with metal surface. It is desirable that all of the foam reagent comes in contact with the metal surface during the course of the decontamination.

1. A process for the chemical decontamination of a radioactive system or a system containing one or more radioactive components, which method comprises applying a chemical decontamination reagent to the radioactive system or the system containing one or more radioactive components in the form of a foam characterised in that a dynamic foam is caused to move through or around the system by means of a gas introduced into the system.

2. A process as claimed in claim 1 wherein the dynamic foam is formed in situ in the system by introducing a liquid volume of the decontamination reagent containing a foaming agent into the system and introducing a gas into the liquid volume of the decontamination reagent to form the foam.

3. A process as claimed in claim 2 wherein the liquid volume of the decontamination reagent occupies from 0.1% to 50% by volume of the system.

4. A process as claimed in claim 3 wherein the liquid volume of the decontamination reagent occupies from 1% to 10% by volume of the system.

5. A process as claimed in any one of the preceding claims wherein the gas is introduced through one or more inlets at the bottom of the system.

6. A process as claimed in any one of the preceding claims wherein the gas is compressed air.

7. A process as claimed in any one of the preceding claims wherein the system comprises an enclosed system of a nuclear plant.

8. A process as claimed in claim 6 wherein the enclosed system comprises a boiler or a turbine.

9. A process as claimed in any one of claims 1 to 6 wherein the system comprises a vessel external to a nuclear plant which contains one or more radioactive components.

10. A process as claimed in any one of the preceding claims wherein the introduction of gas into the liquid is controlled in order to maintain the foam filling the entire volume of the system.

11. A process as claimed in any one of the preceding claims wherein the system is provided with one or more exhaust means for the removal of gas.

12. A process as claimed in any one of the preceding claims where the foam is caused to form and collapse a plurality of times by starting and stopping the gas flow.

13. A process as claimed in any one of the preceding claims wherein the system is rinsed following the chemical decontamination by introducing rinse water at suitable points within the system.
